(19) United States
(12) Patent Application Publication
(10) Pub. No.: US 2026/0003430 A1
(43) Pub. Date: Jan. 1, 2026

(54) FULL DIVE VIRTUAL REALITY UNIT INTEGRATED SYSTEM

(71) Applicant: IOPEX, Inc., Sterling, VA (US)

(72) Inventor: James Bryan Dear, Sterling, VA (US)

(73) Assignee: IMEROPEX, Inc., Dover, DE (US)

(21) Appl. No.: 19/179,044

(22) Filed: Apr. 15, 2025

Related U.S. Application Data
(62) Division of application No. 18/350,415, filed on Jul. 11, 2023, now abandoned.
(60) Provisional application No. 63/401,277, filed on Aug. 26, 2022.

(51) Int. Cl. G06F 3/01; G02B 27/01; G06F 1/16

(52) U.S. Cl. CPC G06F 3/014; G02B 27/017; G06F 1/163; G06F 3/016; G06F 2203/012

(57) ABSTRACT

An integrated full-dive virtual reality unit includes a three-dimensional virtual reality visualization headset; a stationary platform that enables 360° locomotion in the virtual reality environment; a tactile interaction device; a spatial hand tracking device; a motion detection device; a multi-sensory body suit; and a computer. The computer is electronically connected to and integrates data from the three-dimensional virtual reality visualization device, the stationary platform, the tactile interaction device, the motion detection device, and the multi-sensory body suit. Multiple units are integrated in a shared interoperable virtual reality environment by providing the units and virtual reality environment content; synchronizing, handling SDK versions for, and managing tracking capabilities of the hardware; and managing network traffic. Operators running distributed experiments in a cloud computing environment can virtually experience and resolve crises to prevent their occurrence in the real world.

### CROSS-REFERENCE TO RELATED APPLICATION

This application is a division of U.S. application Ser. No. 18/350,415, filed Jul. 11, 2023. application Ser. No. 18/350,415 claimed the benefit of priority of U.S. provisional application No. 63/401,277, filed Aug. 26, 2022. The contents of application Ser. No. 18/350,415 and 63/401,277 are herein incorporated by reference.

### BACKGROUND

The present invention relates to virtual reality (VR) hardware and software and, more particularly, to a full dive virtual reality unit (FDVU) integrated system.

Civilian and military organizations may often face complex crisis situations that could be anticipated and prevented or mitigated, including Black Swan Events like the Sep. 11, 2001 terrorist attacks and the coronavirus disease of 2019 (COVID-19) pandemic, as well as more likely contingencies such as disaster medicine, tactical military encounters, wildfires, active shooters, Industrial Control System (ICS) attacks, law enforcement use of force, and domestic border incursions. Government and private sector managers often wonder how they will prepare for serious (known or unknown) threats to their organizations and missions. Considerations may range from new procedures to new technologies.

Individual vendors develop and market VR headsets, haptic gloves, body suits, treadmills, and software separately for specific customers. All the above devices are designed to operate in isolation and address specific VR functions such as visualization, bodily sensations, locomotion, or haptics. The devices don't work well together because no one vendor integrates the products of other vendors. Presently, there is no available method or device for combining multiple VR devices into a full dive VR unit.

As can be seen, there is a need for a method and system for combining multiple VR devices into an integrated system.

IOPEX, Inc will be providing the Immersive Operational Experimentation (IMEROPEX) service to address these customer concerns. Critical to the realism and success of this service will be the Full Dive VR Units.

### SUMMARY

In one aspect of the present invention, an integrated full-dive virtual reality unit comprises a three-dimensional virtual reality visualization headset; a treadmill platform that enables 360° locomotion in the virtual reality environment; a tactile interaction device; a spatial hand tracking device; a motion detection device; a multi-sensory body suit; and a computer electronically connected to the three-dimensional virtual reality visualization device, the stationary platform, the tactile interaction device, the motion detection device, and the multi-sensory body suit. The computer is operative to integrate data from the three-dimensional virtual reality visualization device, the stationary platform, the tactile interaction device, the motion detection device, and the multi-sensory body suit.

In another aspect of the present invention, a method of integrating a plurality of full dive virtual reality hardware in a shared interoperable virtual reality environment comprises providing the plurality of full dive virtual reality hardware operative to simulate physical feedback sensations; providing virtual reality environment content; handling Software Development Kit (SDK) versions for the plurality of full dive virtual reality hardware; managing tracking capabilities of the plurality of full dive virtual reality hardware; synchronizing the plurality of full dive virtual reality hardware; and managing network traffic for the plurality of full dive virtual reality hardware.

The inventive unit will be employed in Immersive Operational Experiments (IMEROPEXs), that create an alternate virtual reality (VR) where operators can experience and resolve crises and thereby prevent their occurrence in the real world. FDVUs gives operators a more realistic experience during the experiments than prior art VR units. The IMEROPEX Program involves distributed experiments in a cloud computing environment where civilian and military operators take part from their home stations and selected demonstration facilities, immerse themselves (via Full Dive Virtual Reality Units) in crisis action scenarios, and then deconstruct them to understand causality and remediation options.

The Entertainment Industry may employ FDVUs to create an alternate universe to help users escape from the real world, similar to the fictional OASIS envisioned in the book and movie “Ready Player One.”

These and other features, aspects and advantages of the present invention will become better understood with reference to the following drawings, description, and claims.

### BRIEF DESCRIPTION OF THE DRAWINGS

FIG. 1 is a schematic view of a virtual reality crisis training tool according to an embodiment of the present subject matter, shown in use;

FIG. 2 is a chart of themes or clients for which the tool may be used;

FIG. 3 is a schematic diagram of a system according to an embodiment of the present subject matter; and

FIG. 4 is another schematic diagram thereof.

### DETAILED DESCRIPTION

The following detailed description is of modes of carrying out exemplary embodiments of the present subject matter. The description is not to be taken in a limiting sense but is made merely for the purpose of illustrating the general principles of the embodiments of the present subject matter, and is not intended to limit the scope of the appended claims.

As used herein, the term “full dive” refers to an integrated virtual reality experience in which the user immerses his or her senses in a virtual environment. A full dive unit may become a de facto non-invasive brain-computer-interface or, in some cases, an invasive brain-computer-interface may be employed.

Broadly, one embodiment of the present subject matter is a full dive virtual reality unit (FDVU) and/or system.

FDVUs may integrate advanced virtual reality (VR) hardware and software products in a cloud environment to provide a fully immersive, distributed, and multi-sensory VR experience almost indistinguishable from the real world and may be hardware agnostic. FDVUs of the present subject matter integrate these components in a common interoperable VR environment. The overall FDVU configuration may evolve with the advent of new vendor software, hardware, and/or network solutions. For example, hardware miniaturization may contribute to the system becoming less physically cumbersome, more immersive, and less expensive.

The system may comprise multiple individual FDVU hardware components working in sync with each user locally and across a network connection. For example, components may include but are not limited to any combination of a Multi-sensory Body Suit such as a TESLASUIT®, Haptic Gloves (e.g., HAPTX®), VR Headset and tethered computer (e.g., VARJO®), and a Treadmill (e.g., INFINADECK®). Each piece of hardware is physically worn by the user. A VR headset provides a 3D visualization of the VR environment as well as spatial hand tracking. A 360° Treadmill is a stationary platform that provides realistic 360-degree locomotion in the virtual environment. Associated hardware may include inertial sensor pods that attach to the user's feet. Haptic gloves provide tactile interaction with the virtual environment. For example, they may provide about 133 points of tactile feedback and apply up to 40 lbs. (175 N) of resistive force per hand, in conjunction with a smart compressor, an air controller and processing unit, generally worn by the user and driven by a tethered connection. The gloves may also provide motion detection. A Multi-sensory Body Suit provides feelings of pressure, pain, and other sensations using, for example, electro muscle stimulation (EMS) and transcutaneous electrical nerve stimulation (TENS). Software may be used with the suit to simulate physical feedback sensations through preconfigured animation sets or in simulating physics-based object interaction. In some cases, a tracking and stability ring may be worn by the user. These components may be synchronized with each other to provide an operator independent sensory experience. Other suitable components known in the art with similar or improved functionality may also be used. For example, multiple hardware components may provide overlapping functionality, producing overlapping data input. The hardware may be optimized to reduce overlap and/or the software may be optimized to manage overlapping input. In some cases, software solutions may render selected hardware components unnecessary, such as software-based hand tracking with a headset instead of using gloves. The hardware preferably has wireless transmission capabilities, such as Bluetooth® and/or Wi-Fi. The present disclosure envisions new ergonomic solutions to streamline the physical deployment of FDVUs. A power source, such as a rechargeable battery pack, may also be included.

Software utilized by the inventive system may manage (in real time) tracking capabilities of the system's FDVU components as well as latency. Latency is preferably maintained below a level that compromises the immersive environment, e.g., below about 15 milliseconds (ms), particularly as the number of interacting users increases. A VR Game Engine (e.g., UNREAL®) may provide the content for the 3D Virtual Reality environment, ensuring individual realism and immersion. The software may include a software handler operative to allow disparate hardware to use the same VR Software Development Kit (SDK) version, i.e., a single version used commonly by all the hardware. The hardware and software may be integrated with Steam® VR, for example. Alternatively, a software abstraction handler may allow hardware to use separate SDK or system software requirements. An individual FDVU may be synchronized and interact with remote FDVUs via middleware, cloud computing, and related selected network configurations. Middleware facilitates communication of the simulation events between all the components to ensure synchronization. The simulation state for all users, the user location in relation to all other users, the user hardware state (haptic information), and simulation data (captured to recreate simulation sessions) may be determined and transmitted between all users and the server. Middleware synchronizing the hardware (HW) systems may evolve as the individual components evolve. Cloud computing provides a distributed environment for near real-time VR interactions of remote operators. The software may operate over a networking service operative to manage, i.e., control and monitor, network traffic for the disparate hardware from end user to server and server to end users, including the size and frequency of information sent to a server as well as end user updates for a simulation. Networking may be provided by a variety of cloud providers.

In some embodiments, the integration and configuration may result in an FDVU that generates an alternate reality indistinguishable from the real world. Civilian and military entities may place operators in FDVUs to immerse them in various crisis action scenarios with such fidelity that they experience and understand the events, enabling the operators to deconstruct the events and prevent or limit their occurrence in the real world. Employing FDVUs in Immersive Operation Experiments (IOPEXs) may prevent or limit an actual crisis by assisting operators to employ and develop new tactics/procedures, new technologies, and other data-driven recommendations.

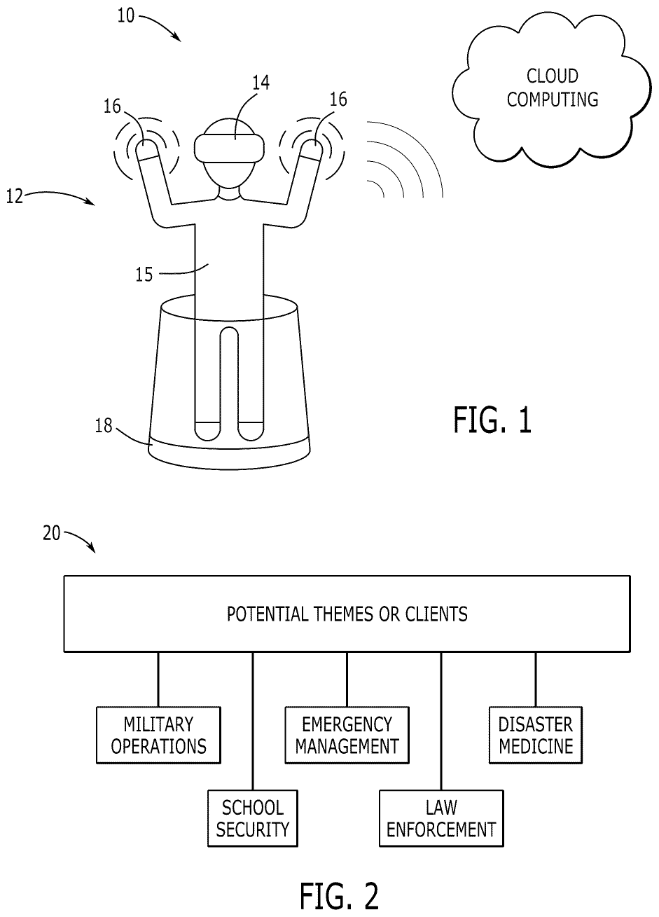

Referring to FIGS. 1 through 4, FIG. 1 illustrates a full-dive VR unit 10 according to an embodiment. The operator 12 wears a headset 14, a multi-sensory body suit 15, and haptic gloves 16, and is positioned on a 360° treadmill 18. Data collected from the unit 10 is transmitted wirelessly to a server or servers on the cloud.

As shown in FIG. 2, the full-dive VR unit 10 may be used for a variety of themes or clients 20, such as military operations, school security, emergency management, law enforcement, and disaster medicine.

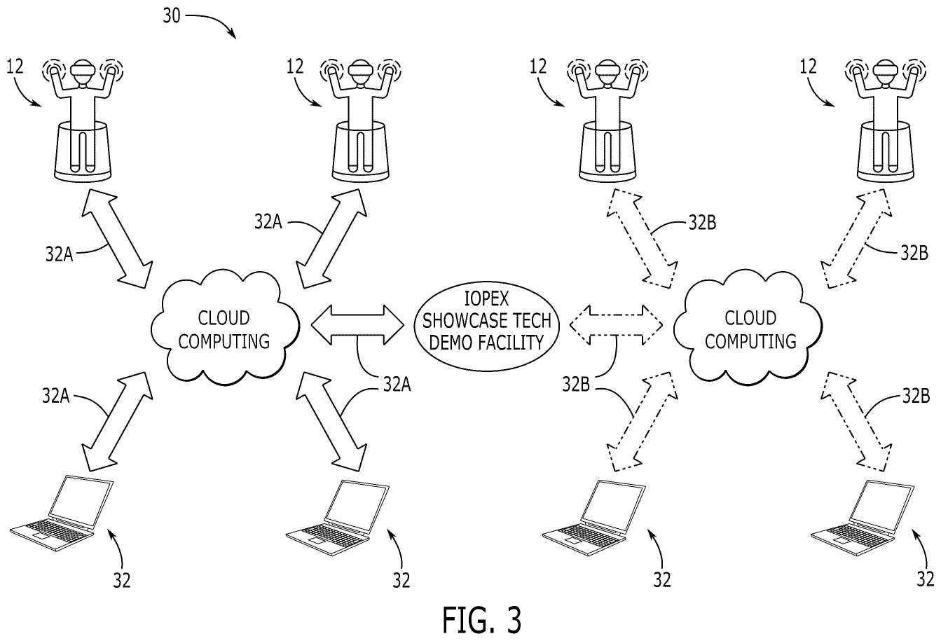

A multi-unit system 30 integrates a plurality of operators 12, each utilizing a full-dive VR unit 10, as seen in FIG. 3. The units 10 interact by sending and receiving data 32A, 32B, to server(s) on the cloud, while a scenario is managed utilizing client computers 32.

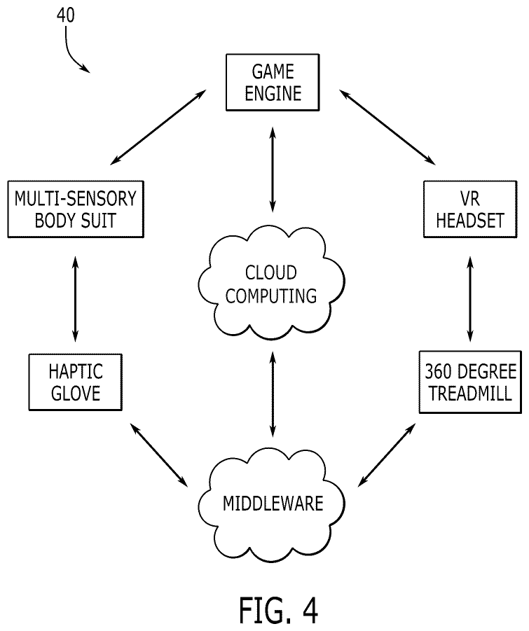

FIG. 4 shows a system diagram 40 of a unit comprising a multi-sensory body suit, haptic gloves, a VR headset, and a 360° treadmill, integrated utilizing middleware and operating a game engine via cloud computing.

It should be understood, of course, that the foregoing relates to exemplary embodiments of the invention and that modifications may be made without departing from the spirit and scope of the invention as set forth in the following claims.

What is claimed is:

1. A method of integrating a plurality of full dive virtual reality hardware in a shared interoperable virtual reality environment, comprising:
providing the plurality of full dive virtual reality hardware operative to simulate physical feedback sensations;
providing virtual reality environment content;
handling Software Development Kit (SDK) versions for the plurality of full dive virtual reality hardware;
managing tracking capabilities of the plurality of full dive virtual reality hardware;
synchronizing the plurality of full dive virtual reality hardware; and
managing network traffic for the plurality of full dive virtual reality hardware.

2. The method of claim 1, further comprising maintaining latency below about 15 milliseconds.

3. The method of claim 1, further comprising determining a simulation state, a user location, haptic information, and simulation data for a plurality of users;
and transmitting the simulation state, the user location, the haptic information, and the simulation data to the plurality of users.

4. A method for providing a fully immersive crisis simulation experience in a distributed full dive virtual reality environment, comprising:
receiving, at a computing device, sensor data from a plurality of full dive virtual reality hardware components, the full dive virtual reality hardware components including a three-dimensional virtual reality visualization headset, a treadmill platform configured to enable 360° locomotion, a tactile interaction device, a spatial hand tracking device, a motion detection device, and a multi-sensory body suit;
processing the sensor data to generate an integrated simulation state for the distributed full dive virtual reality environment and user interactions in a crisis simulation scenario, the integrated simulation state comprising motion data, and haptic data;
synchronizing the integrated simulation state with virtual reality environment content provided by a virtual reality game engine;
transmitting the integrated simulation state to one or more of the plurality of full dive virtual reality hardware components via a network; and
maintaining a near real-time simulation of the crisis simulation scenario, wherein network communication is maintained at a latency below about 15 milliseconds.

5. The method of claim 4, wherein transmitting the integrated simulation state further comprises: providing the integrated simulation state via a cloud computing network to enable distributed immersive experiences among users.

6. The method of claim 4, wherein the sensor data is received wirelessly from the full dive virtual reality hardware components.

7. The method of claim 4, further comprising: utilizing middleware configured to synchronize simulation state updates among the plurality of full dive virtual reality hardware components.
